(19) United States
(12) Patent Application Publication
(10) Pub. No.: US 2015/0177004 A1
(43) Pub. Date: Jun. 25, 2015

(54) ROADBLOCK DEVICE, ROAD CONDITION MANAGEMENT DEVICE, AND METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-YUAN YANG, New Taipei (TW); QING-LIANG GUO, Shenzhen (CN)

(21) Appl. No.: 14/539,586

(22) Filed: Nov. 12, 2014

(30) Foreign Application Priority Data
Dec. 25, 2013 (CN) 201310725072.8

(51) Int. Cl. G01C 21/26; G01S 19/13

(52) U.S. Cl. CPC G01C 21/26; G01S 19/13

(57) ABSTRACT

A road condition management method includes: obtaining geographical location information sent by at least one roadblock device, wherein each geographical location information comprises a geographical location of the corresponding roadblock device; storing the obtained geographical location information to a storage device; and generating a corresponding road condition prompting information related to an target area according to the geographical location information stored in the storage device in response to a search request for searching a road condition of the target area sent by a terminal device.

### CROSS-REFERENCE TO RELATED APPLICATIONS

This application claims priority to Chinese Patent Application No. 201310725072.8 filed on Dec. 25, 2013, the contents of which are incorporated by reference herein.

### FIELD

The present disclosure relates to management devices, and particularly to a road condition management device and a roadblock device.

### BACKGROUND

Often, an area of a road is blocked by a roadblock device to prevent vehicles from passing through due to road construction or breakdowns. However, people usually do not learn that the road is blocked until seeing the roadblock device.

### BRIEF DESCRIPTION OF THE DRAWINGS

Implementations of the present technology will now be described, by way of example only, with reference to the attached figures.

FIG. 1 is a block diagram of an embodiment of a roadblock device and a road condition management device coupled to each other.

FIG. 2 a flowchart diagram of an embodiment of a road condition management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected. The term “coupled” is defined as connected, whether directly or indirectly through intervening components, and is not necessarily limited to physical connections.

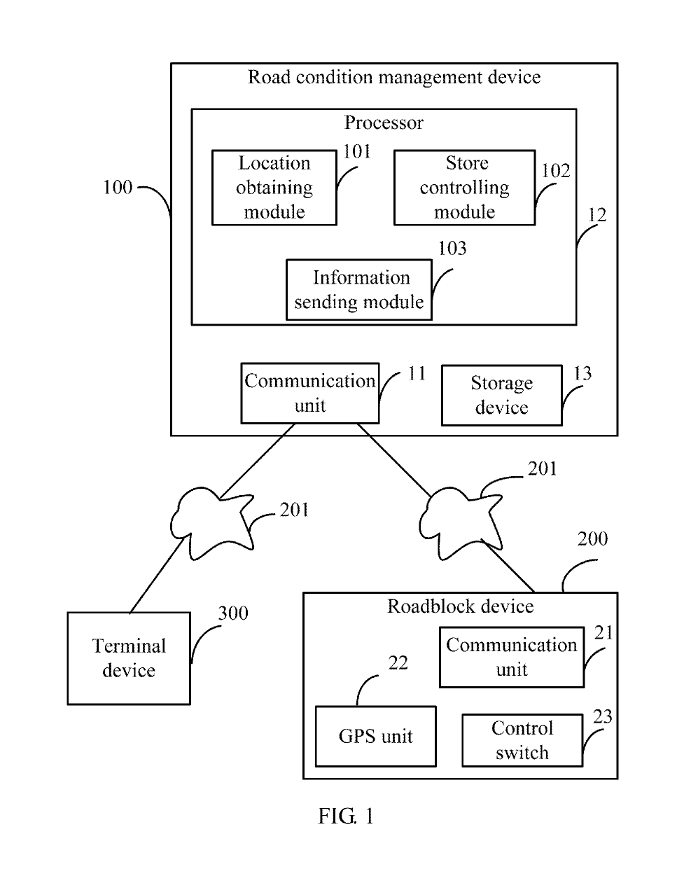

Referring to FIG. 1, a road condition management device 100 and at least one roadblock device 200 are illustrated. The road condition management device 100 is connected to the at least one roadblock device 200 via a network 201. The road condition management device 100 can be a server or a server group. The network 201 can be Internet, a wireless network including WIFI and BLUETOOTH®, a telecommunication network including a general packet radio service (GPRS) network and a code division multiple access (CDMA) network, or a broadcasting network. The roadblock device 200 can be put on an area of a road where is abnormally, such as road work or breakdown.

The road condition management device 100 includes a communication unit 11, a processor 12, and a storage device 13. Each roadblock device 200 includes a communication unit 21 and a global position system (GPS) unit 22.

The communication unit 11 of the road condition management device 100 communicates with the communication unit 21 via of each roadblock device 200 via the network 201, thus to establish a communication connection between the road condition management device 100 and each roadblock device 200. The communication units 11, 21 can be wireless network cards (such as the 3rd generation telecommunication network card, the 4rd generation telecommunication network card), wired network cards (such as network chip), or phone cards.

The GPS unit 22 is used to locate a geographical location of the roadblock device 200. The GPS unit 22 can be a GPS navigation device.

A number of modules are stored in the storage device 13 and executed by the processor 12. The modules includes at least a location obtaining module 101, a store controlling module 102, and an information sending module 103. The position obtaining module 101, the store controlling module 102, and the information sending module 103 can be collections of software instructions stored in the storage device 13 and executed by the processor 12, or can include functionality represented as hardware or integrated circuits, or as software and hardware combinations, such as a special-purpose processor or a general-purpose processor with special-purpose firmware.

In one embodiment, the processor 12 can be a central processing unit, a digital signal processor, or a single chip, for example. In one embodiment, the storage device 13 can be an internal storage system, such as a flash memory, a random access memory (RAM) for temporary storage of information, and/or a read-only memory (ROM) for permanent storage of information. The storage device 13 can also be a storage system, such as a hard disk, a storage card, or a data storage medium. The storage device 13 can include volatile and/or non-volatile storage devices. In at least one embodiment, the storage device 13 can include two or more storage devices such that one storage device is a memory and the other storage device is a hard drive. Additionally, one or more of the storage devices 13 can be located either entirely or partially external relative to the road condition management device 100.

The location obtaining module 101 is used to obtain at least one geographical location information sent by at least one roadblock device 200. Each geographical location information includes a geographical location of a corresponding roadblock device 200 sending the geographical location information. In the embodiment, each roadblock device 200 includes a control switch 23, the control switch 23 is used to turn on or turn off the GPS unit 22. That is, the GPS unit 22 can be turned on or off in response to operations on the control switch 23 by a person, such as a staffer, thus to cause the GPS unit 22 to work or not to work. Therefore, when an area of the road is abnormal, the staffer can put at least one roadblock device 200 on the area, and turn on the GPS unit 22 via the control switch 23. Therefore, the GPS unit 22 is enabled to locate the geographical location of the roadblock device 200 and send the geographical location of the roadblock device 200 to the road condition management device 100.

Because the GPS unit 22 is turned on only when the area of the road is abnormal, the roadblock device 200 sends the geographical location only when the area of the road is abnormal, the geographical location information received by the location obtaining module 21 is the geographical location of the roadblock device 200 located in the area of the road where is abnormal.

The store controlling module 102 is used to store the obtained geographical location information of the roadblock device 200 to the storage device 13.

The information sending module 103 is used to generate a road condition prompting information related to an target area according to the geographical location information stored in the storage device 13 in response to a search request sent by a terminal device 300 for searching a road condition of the target area. The information sending module 103 further sends the road condition prompting information to the terminal device 300.

In detail, the information sending module 103 determines whether the storage device 13 stores one geographical location information including a geographical location located in the target area. That is, the information sending module 103 determines whether the geographical location of one roadblock device 200 stored in the storage device 13 is located in the target area. If yes, namely, the storage device 13 stores the geographical location information including the geographical location located in the target area, the information sending module 103 generates and sends a first road condition prompting information to the terminal device 300. If not, namely the storage device 13 does not stores the geographical location information including the geographical location located in the target area, the information sending module 103 generates and sends a second road condition prompting information to the terminal device 300. In the embodiment, the first road condition prompting information includes content about the target area is abnormal, the second road condition prompting information includes content about the road condition of the target area is normal.

As shown in FIG. 1, the terminal device 300 can communicate with the road condition management device 100 via the network 201. The terminal device 300 can be a mobile phone, a tablet computer, a portable computer, or a desktop computer, used by a person to search a road condition of an area. For example, when the person want to know a road condition of one area, the person can send the search request for searching the road condition of the target area to the road condition management device 100.

In at least one embodiment, the terminal device 300 can install a client application, and the user of the terminal device 300 can establish the communication connection between the terminal device 300 and the road condition management device 100, and send the search request to the road condition management device 100 via the client application.

In at least one embodiment, after the GPS unit 22 of the roadblock device 200 is turned on, the GPS unit 22 sends the geographical location information to the road condition management device 100 in real time. After the GPS unit 22 of the roadblock device 200 is turned off, the GPS unit 22 is disabled and stops sending the geographical location information to the road condition management device 100.

In at least one embodiment, the location obtaining module 101 obtains the at least one geographical location information sent by the at least one roadblock device 200 at intervals (such as every 10 minutes). The store controlling module 102 updates the geographical location information stored in the storage device 13 according to the obtained geographical location information at intervals accordingly. That is, the store controlling module 102 stores the obtained geographical location information to the storage device 13 to replace the geographical location information previously stored in the storage device 13. For example, if the all of geographical location information currently obtained by the location obtaining module 101 are three geographical location information respectively sent by three roadblock devices 200, the store controlling module 102 stores the currently obtained three geographical location information to the storage device 13 to replace the geographical location information previously stored in the storage device 13.

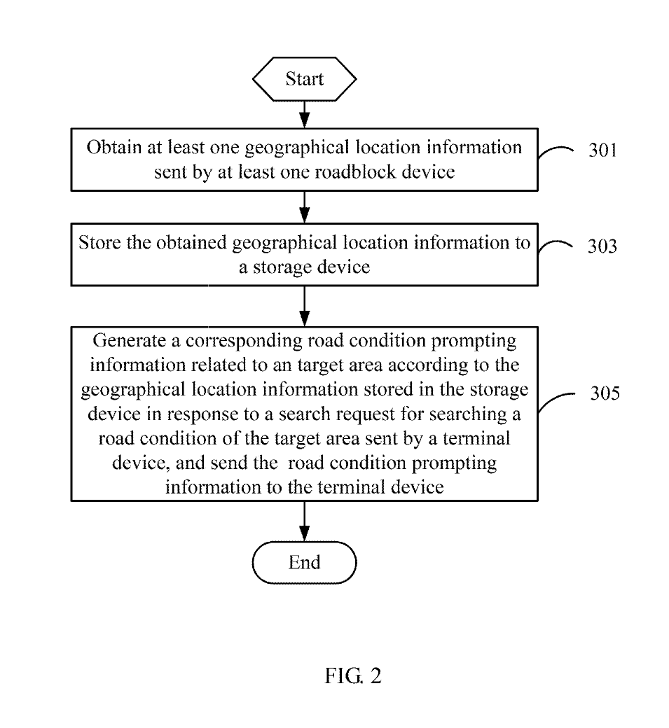

FIG. 2 illustrates a flowchart of a road condition management method. The method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Additionally, the illustrated order of blocks is by example only and the order of the blocks can be changed. The example method can begin at block 301.

In block 301, an location obtaining module obtains at least one geographical location information sent by at least one roadblock device, each geographical location information includes a geographical location of the corresponding roadblock device.

In block 303, a store controlling module is used to store the obtained geographical location information to the storage device. In detail, the location obtaining module obtains the at least one geographical location information sent by the at least one roadblock device at intervals, and the store controlling module updates the geographical location information stored in the storage device according to the obtained geographical location information at intervals.

In block 305, an information sending module generates a corresponding road condition prompting information related to an target area according to the geographical location information stored in the storage device in response to a search request sent by a terminal device for searching a road condition of the target area, and sends the corresponding road condition prompting information to the terminal device. In detail, the information sending module determines whether the storage device stores one geographical location information including a geographical location located in the target area, if yes, the information sending module generates and sends a first road condition prompting information to the terminal device. If not, the information sending module generates and sends a second road condition prompting information to the terminal device. The first road condition prompting information includes content about the target area is abnormal, the second road condition prompting information includes content about the road condition of the target area is normal.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A road condition management device comprising:
a communication unit configured to communicate with at least one roadblock device and at least one terminal device;
a storage device configured to store a plurality of modules which are collections of instructions; and
at least one processor configured to execute the plurality of modules, the modules comprising:
a location obtaining module configured to obtain at least one geographical location information respectively sent by the at least one roadblock device, wherein each geographical location information comprises a geographical location of a corresponding roadblock device sending the geographical location information;
a store controlling module configured to store the at least one geographical location information sent by the at least one the roadblock device to the storage device; and
an information sending module configured to generate a road condition prompting information related to a target area according to the geographical location information stored in the storage device, in response to a search request sent by the terminal device for searching a road condition of the target area.

2. The road condition management device according to claim 1, wherein the information sending module determines whether the storage device stores one geographical location information including a geographical location located in the target area, if the storage device stores the geographical location information including the geographical location located in the target area, the information sending module generates and sends a first road condition prompting information to the terminal device; if the storage device does not stores the geographical location information including the geographical location located in the target area, the information sending module generates and sends a second road condition prompting information to the terminal device.

3. The road condition management device according to claim 2, wherein the first road condition prompting information comprises content about the road condition of the target area is abnormal, the second road condition prompting information comprises content about the road condition of the road condition of the target area is normal.

4. The road condition management device according to claim 1, wherein the location obtaining module obtains the at least one geographical location information sent by the at least one roadblock device at intervals, the store controlling module updates the geographical location information stored in the storage device according to the obtained geographical location information at intervals accordingly.

5. The road condition management device according to claim 1, wherein road condition management device is a server or a server group.

6. A roadblock device comprising:
a communication unit configured to communicate with a road condition management device; and
a global position system (GPS) unit configured to locate a geographical location of the roadblock device and send geographical location information comprising the geographical location of the roadblock device to the road condition management device via the communication unit.

7. The roadblock device according to claim 6, further comprising a control switch configured to turn on or turn off the GPS unit in response to a corresponding operation by a person.

8. The roadblock device according to claim 6, wherein the GPS unit sends the geographical location information to the road condition management device in real time after the GPS unit is turned on, and the GPS unit is disabled and stops sending the geographical location information to the road condition management device after the GPS unit is turned off.

9. A road condition management method comprising:
obtaining at least one geographical location information respectively sent by at least one roadblock device, wherein each geographical location information comprises a geographical location of a corresponding roadblock device;
storing the at least one geographical location information to a storage device; and
generating a corresponding road condition prompting information related to a target area according to the geographical location information stored in the storage device in response to a search request sent by a terminal device for searching a road condition of the target area, and sending the corresponding road condition prompting information to the terminal device.

10. The method according to claim 9, wherein the step of generating a corresponding road condition prompting information related to a target area according to the geographical location information stored in the storage device in response to a search request sent by a terminal device for searching a road condition of the target area comprises:
determining whether the storage device stores one geographical location information comprising a geographical location located in the target area;
generating a first road condition prompting information to the terminal device if the storage device stores the geographical location information comprising the geographical location located in the target area; and
generating a second road condition prompting information to the terminal device if the storage device does not stores the geographical location information comprising the geographical location located in the target area.

11. The method according to claim 10, wherein the first road condition prompting information comprises content about the road condition of the target area is abnormal, the second road condition prompting information comprises content about the road condition of the road condition of the target area is normal.

12. The method according to claim 9, wherein the step of storing the obtained geographical location information to a storage device comprises:
storing the obtained geographical location information to the storage device to replace the geographical location information previously stored in the storage device.
